(19) United States
(12) Patent Application Publication
(10) Pub. No.: US 2009/0192018 A1
(43) Pub. Date: Jul. 30, 2009

(54) Method and Control Unit for Controlling a Drivetrain Which has a Dual-clutch Transmission

(75) Inventors: Jan-Peter Hoffmeister, Leonberg (DE); Peter Baur, Moensheim (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, WEISSACH (DE)

(21) Appl. No.: 12/359,363

(22) Filed: Jan. 26, 2009

(30) Foreign Application Priority Data
Jan. 26, 2008 (DE) 10 2008 006 194.8

(51) Int. Cl. B60W 10/02; G06F 17/00; B60W 30/18

(52) U.S. Cl. 477/176; 701/67

(57) ABSTRACT

A method for controlling the drivetrain of a motor vehicle which has a dual-clutch transmission with a first partial transmission and a first clutch and with a second partial transmission and a second clutch. The drivetrain is operated with a gear being engaged in the first partial transmission and a gear engaged in the second partial transmission at the same time and with the first clutch and the second clutch being operated with slip at the same time. The first clutch and the second clutch are activated in a manner coordinated with one another in such a way that a rotational speed of the internal combustion engine assumes or maintains a predetermined value. A control unit is set up for carrying out the method.

### CROSS-REFERENCE TO RELATED APPLICATION

This application claims the priority, under 35 U.S.C. §119, of German application DE 10 2008 006 194.8, filed Jan. 26, 2008; the prior application is herewith incorporated by reference in its entirety.

### BACKGROUND OF THE INVENTION

1. Field of the Invention

The invention relates to a method for controlling the drivetrain of a motor vehicle which has a dual-clutch transmission with a first partial transmission and a first clutch and with a second partial transmission and a second clutch. The drivetrain is operated with a gear being engaged in the first partial transmission and a gear being engaged in the second partial transmission at the same time and with the first clutch and the second clutch being operated with slip at the same time. The invention also relates to a control unit which is set up for carrying out the method.

A method of this type and a control unit of this type are each known from series-produced motor vehicles. The division of the dual-clutch transmission into a first partial transmission and a second partial transmission which can be connected, independently of one another, to the drive engine of the drivetrain by the first and second clutch respectively, permits a change in transmission ratios without an interruption in tractive force. During starting, the drive motor drives the motor vehicle generally first via the first clutch and the first partial transmission. Here, when the (second) clutch of the second partial transmission is open, the second gear can already be engaged in the second partial transmission. During the transfer of the transmission of torque from a transmission via the first partial transmission to a transmission via the second partial transmission, the two clutches are briefly operated with slip at the same time, with the transmission of torque via the first clutch decreasing and via the second clutch increasing. The torques which are transmitted via the two clutches at the same time in the transfer phase are added in the dual-clutch transmission. After the transfer has taken place, the second clutch is completely closed. After the transfer is complete, the motor vehicle is accelerated further in the second gear. On account of the change in transmission ratio, the relationship between the engine rotational speed and driving speed changes. The opening and closing of the clutches and the resulting rotational speed changes incite oscillations in the drivetrain.

During driving at low speeds in the lowest part-load range, that is to say with only a very low torque demand by the driver, comfort plays a greater role than other properties, for example a sporty driving behavior. In particular at a walking pace between approximately 5 and 15 km/h, longitudinal oscillations of the vehicle, which are caused by the shifts, or perceptible jolts, which are caused by load changes, or vibrations, which are caused by the charge exchange during the charging of combustion chambers of the drive engine, are perceived to be disturbing.

For example, overrun and part-load shifts during coasting (stopping) lead to uncomfortable longitudinal vibrations and traction/overrun load changes. A late opening of the clutch of the first gear shortly before stopping also leads, as a result of the resulting relief of load from the drivetrain, to a perceptible change in the longitudinal deceleration. If appropriate, downshifts are carried out even with an intermediate application of the throttle, and increase fuel consumption.

During driving at constant speed at very low speeds of for example 5 km/h-15 km/h, as typically occurs in stop-and-go operation, shifts lead to changes in speed and to uncomfortable longitudinal oscillations which the driver must compensate by throttle pedal corrections. Furthermore, jolt effects and/or acceleration effects caused by mass inertia effects, changes in torque and changes in transmission ratio can be perceived during the shifts. As a result of the rotational speed influence, both the engine torque and also the engine power are varied, as a result of which the driver is forced to correct the throttle pedal angle. Frequent upshifts and downshifts are undesirable on account of the low level of hysteresis (speed interval), and yet are likely.

### SUMMARY OF THE INVENTION

It is accordingly an object of the invention to provide a method and a control unit for controlling a drivetrain which has a dual-clutch transmission which overcomes the above-mentioned disadvantages of the prior art methods and devices of this general type, by which the driving comfort under the stated conditions is improved.

With the foregoing and other objects in view there is provided, in accordance with the invention, a method for controlling a drivetrain of a motor vehicle having a dual-clutch transmission with a first partial transmission and a first clutch and with a second partial transmission and a second clutch. The method includes operating the drivetrain with a gear engaged in the first partial transmission and a further gear engaged in the second partial transmission at a same time; and operating the first clutch and the second clutch with slip at a same time. The first clutch and the second clutch are activated in a manner coordinated with one another such that a rotational speed of an internal combustion engine one of assumes a predetermined value and maintains the predetermined value.

Here, the first and the second clutch are each activated in a manner coordinated with one another in such a way that a rotational speed of the internal combustion engine assumes or maintains a predetermined value. In other words, instead of completely closing the one clutch in the present gear and completely opening the other clutch, the two clutches are operated with slip, preferably with regulated slip, in order to obtain a comfortable driving behavior.

By this features, it is achieved that, when driving slowly, the engine rotational speed, following a nominal rotational speed, smoothly aligns with a target rotational speed without pronounced local rotational speed minima and rotational speed maxima. When stopping, the target rotational speed may for example be the idle rotational speed. In contrast, in the case of a permanently closed clutch, as is conventional in the prior art, the engine rotational speed could, specifically when driving slowly in 1^{st} and 2^{nd} gear, fall below a target rotational speed. To prevent this, it is known to allow an upshift to take place later and to allow the downshift, for example into first gear, to take place earlier, which increases fuel consumption and is associated with losses in comfort. In contrast, the low engine rotational speeds of for example 700 rpm to 1200 rpm obtained with the invention help to reduce fuel consumption.

It is self-evident that the features specified above and the features yet to be explained below can be used not only in the respectively specified combination but also in other combinations or individually without departing from the scope of the present invention.

Other features which are considered as characteristic for the invention are set forth in the appended claims.

Although the invention is illustrated and described herein as embodied in a method and a control unit for controlling a drivetrain which has a dual-clutch transmission, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of a drivetrain according to the invention;

FIG. 2 is a graph showing profiles of different operating parameters of the drivetrain from FIG. 1 in the event of the drivetrain being controlled, over time, according to the prior art during stopping of the vehicle;

FIG. 3 is a flow diagram showing as an exemplary embodiment a method according to the invention;

FIG. 4 is a chart showing a smoothed profile of the rotational speed of the internal combustion engine as is generated with the subject matter of the present invention during stopping of the vehicle; and

FIG. 5 is a chart showing a profile of the engine rotational speed with an exemplary embodiment of the invention in a transmission ratio map which illustrates linear dependencies of the engine rotational speed nMot on the driving speed v for the different gears of the dual-clutch transmission.

### DETAILED DESCRIPTION OF THE INVENTION

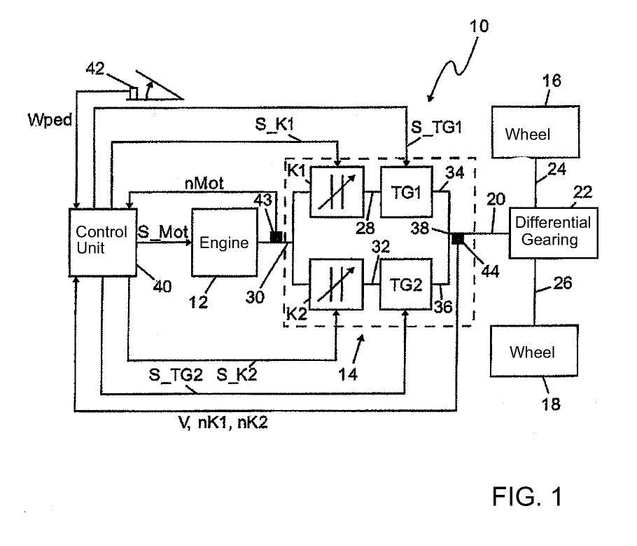

Referring now to the figures of the drawing in detail and first, particularly, to FIG. 1 thereof, there is shown a drivetrain 10 of a motor vehicle. The drivetrain 10 has an internal combustion engine 12, a dual-clutch transmission 14 and further transmissions and/or shafts for transmitting power between drive wheels 16, 18 of the motor vehicle and the internal combustion engine 12. In FIG. 1, a shaft 20 serves to transmit power between the dual-clutch transmission 14 and a differential gearing 22, while driveshafts 24, 26 transmit power between the differential gearing 22 and the two drive wheels 16, 18. Such an arrangement is typical for a motor vehicle with a front-mounted engine and rear-wheel drive. The invention is however not restricted to use in the illustrated drivetrain 10 and may also be used in drivetrains with front-wheel drive, all-wheel drive or rear-wheel drive with a transaxle design.

The dual-clutch transmission 14 has a first partial transmission TG1 and a second partial transmission TG2. A torque flow between an input shaft 28 of the first partial transmission TG1 and a crankshaft 30 of the internal combustion engine 12 takes place via a first controllable clutch K1. A torque flow between an input shaft 32 of the second partial transmission TG2 and the crankshaft 30 of the internal combustion engine 12 takes place via a second controllable clutch K2. In one embodiment, the first partial transmission TG1 provides transmission stages (gears) with odd numbering, such as the first gear, the third gear and so on, while the second partial transmission TG2 provides the transmission stages (gears) with even numbering, such as the second gear, the fourth gear and so on.

Both a main shaft 34 of the first partial transmission TG1 and also a main shaft 36 of the second partial transmission TG2 is rotationally fixedly connected to the shaft 20. The shafts 34 and 36 therefore rotate at the same rotational speed which, when the motor vehicle is driving in a straight line without slip at the drive wheels 16, 18, is linearly dependent on the rotational speed of the drive wheels 16, 18 and therefore linearly dependent on the driving speed v of the vehicle. In the schematic illustration of FIG. 1, the torques of the shafts 34 and 36 are added at the junction 38 to form the torque which acts in the shaft 20.

In the embodiment of FIG. 1, a control unit 40 controls the entire drivetrain 10, that is to say the internal combustion engine 12 and the dual-clutch transmission 14. It is self-evident that a combination of a plurality of control units may also be used instead of a single control unit 40, which control units themselves may be coordinated by a central control unit or may communicate with one another by a bus system in order to coordinate their individual actuating interventions into the drivetrain 10.

To control the drivetrain 10, the control unit 40 processes signals from a multiplicity of sensors which measure operating parameters of the drivetrain 10. Here, in connection with the invention, the following operating parameters are of particular significance: a throttle pedal angle Wped, which is provided by a driver demand transducer 42 and which represents a torque demand by the driver, a rotational speed nMot of the crankshaft 30 of the internal combustion engine 12, which rotational speed nMot is measured by a rotational speed sensor 43, and a vehicle speed v which is measured by a driving speed transducer 44. In one embodiment, the driving speed transducer 44 is realized as a rotational speed sensor which measures a rotational speed at the outlet of the dual-clutch transmission 14, that is to say a rotational speed of one of the shafts 34, 36 or 20. Alternatively or in addition, a rotational speed signal is measured at one or more of the wheels 16, 18, for example by the sensor arrangement of an anti-lock brake system.

With the knowledge of the transmission ratios set in each of the partial transmissions TG1 and TG2, the rotational speed nK1 of the input shaft 28 of the first partial transmission TG1 and the rotational speed nK2 of the input shaft 32 of the second partial transmission TG2 are each given by a linear function of the driving speed v.

As a function of the operating parameters of the drivetrain 10, and if appropriate as a function of further operating parameters, in particular as a function of operating parameters of the internal combustion engine 12, the control unit 40 forms actuating signals S_Mot, S_K1, S_K2, S_TG1 and S_TG2. Here, the actuating signal S_Mot serves to set a torque of the internal combustion engine 12. The actuating signal S_TG1 serves to engage a gear in the first partial transmission TG1 and therefore to set its transmission ratio. Similarly, the actuating signal S_TG2 serves to set a transmission ratio in the second partial transmission TG2. With the actuating signal S_K1, the torque flow via the first clutch K1 is controlled. Similarly, the torque flow via the second clutch K2 is controlled with the actuating signal S_K2.

The relationship of the actuating signals S_K1, S_K2 to the torque transmitted in each case via each of the two clutches K1, K2 at certain rotational speed differences is preferably stored in the control unit 40 in the form of characteristic curves or characteristic maps. This is prior art. The rotational speed differences are likewise known in the control unit 40 by evaluating the rotational speed values nMot and nK1, nK2. The engine torque is also known, the engine torque being calculated continuously by the control unit 40 from characteristic operating variables of the internal combustion engine 12, since modern engine controllers determine all actuating variables on the basis of torque demands which are calculated for example as a function of the throttle pedal angle Wped.

The control unit 40 determines, from the sign of the rotational speed difference at each of the clutches K1, K2, the direction of the torque being transmitted in each case, and from the actuation signal S_K1, S_K2 which is ultimately reproduced in the contact pressure of the clutch friction surfaces, the value of the torque being transmitted via each of the two clutches K1, K2.

The control unit 40 can therefore distribute the torque flow via the two clutches K1, K2 in a controlled manner, and thereby control the direction and magnitude of the resultant total torque flow, in order to set the engine rotational speed nMot to a nominal value, or nominal value profile over time or over the driving speed v, by coordinated activation of the two clutches K1, K2.

The control unit 40, or a corresponding combination of control units, is otherwise set up, in particular programmed, to carry out the method according to the invention, or one of its embodiments. Here, to carry out is to be understood to mean to control the method processes described here.

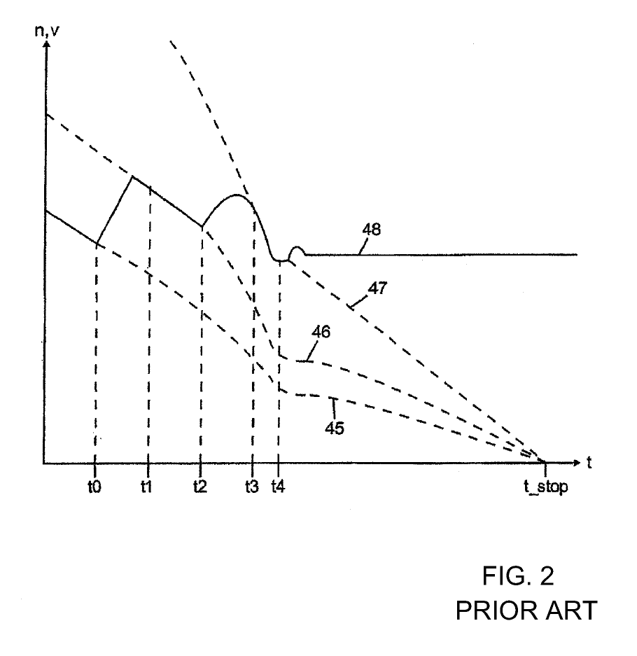

FIG. 2 shows the generation of the disturbing jolts and/or longitudinal oscillations described in the introduction. For this purpose, FIG. 2 shows profiles of different operating parameters of the drivetrain 10 from FIG. 1 in the event of the drivetrain 10 being controlled, over time t, according to the prior art during stopping of the vehicle. Here, the dashed lines 45, 46 and 47 represent, in this sequence, the rotational speed nK1_Gang 3 of the input shaft 28 of the partial transmission TG1 in the third gear, the rotational speed nK2_Gang 2 of the input shaft 32 of the second partial transmission TG2 in the second gear, and the rotational speed nK1_Gang 1 of the input shaft 28 of the first partial transmission TG1 in the first gear. The solid line 48 represents the associated time profile of the rotational speed nMot. If no slip occurs at the wheels 16, 18, the driving speed v is proportional, in each case with a factor which is dependent on the respective transmission ratio, to the vehicle speed v. Each of the three dashed lines 45, 46 and 47 therefore represents not quantitatively but qualitatively the profile of the vehicle speed v until the motor vehicle comes to a standstill at the time t_stop.

Until the time t0, the vehicle decelerates in the third gear with the clutch K1 closed. The clutch K2 is open. The engine rotational speed nMot corresponds there to the rotational speed nK1_Gang 3. In parallel, with the clutch K2 open, the second gear in the second partial transmission TG2 is engaged. Between the times t0 and t1, the first clutch K1 is opened to an increasing extent and the clutch K2 is closed to an increasing extent until, at the time t1, the clutch K1 is fully open and the clutch K2 is fully closed. The rotational speed nMot correspondingly rises while the clutches K1, K2 are slipping until the time t1, before then falling again during the further deceleration of the vehicle with the clutch K2 closed and the clutch K1 open.

With the clutch K1 open, after the time t1, the first gear in the first partial transmission TG1 is engaged. Between the times t2 and t3, the second clutch K2 is opened to an increasing extent and the first clutch K1 is closed to an increasing extent. As a result, the rotational speed nMot of the internal combustion engine 12 rises to a value predefined by the curve 47. The rotational speed nMot then falls again during the further deceleration of the vehicle, until the value of the idle rotational speed is reached at the time t4.

To prevent the rotational speed nMot falling below the idle rotational speed of the internal combustion engine, the clutch K1 is opened at the time t4. The rotational speed nMot is then held at a constant value by known idle rotational speed regulation. The change between local rotational speed minima and local rotational speed maxima which can be seen in the profile 48 before the time t4 are generated in that the rotational speed of the internal combustion engine 12 is raised between the times t0 and t1 and the times t2 and t3, in each case at the expense of the kinetic energy of the vehicle. The braking action of the internal combustion engine 12 therefore varies and incites the oscillations in the drivetrain 10, which are reproduced in undesired longitudinal oscillations of the vehicle. Similarly, the jolt as the clutch K1 is opened at the time t4 is a disturbance which can incite oscillations or which can be perceived as a jolt.

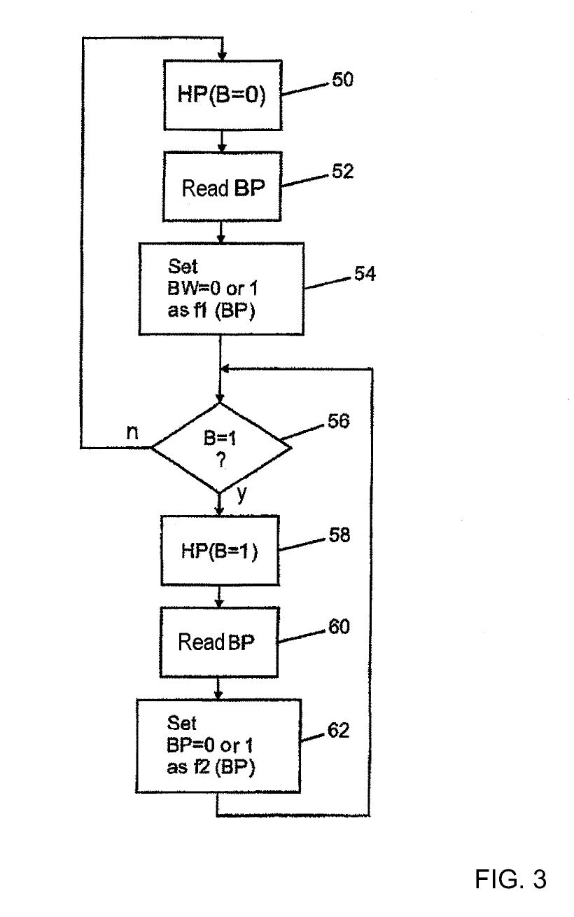

FIG. 3 shows a flow diagram as an exemplary embodiment of a method according to the invention. Step 50 represents a main program HP(B=0) for controlling the drivetrain 10 for the case that a parameter B has the value 0. In this case, (B=0), the drivetrain 10 is controlled in a known way. The profile, illustrated in FIG. 2, of the engine speed nMot with the explained maxima and minima is for example then generated.

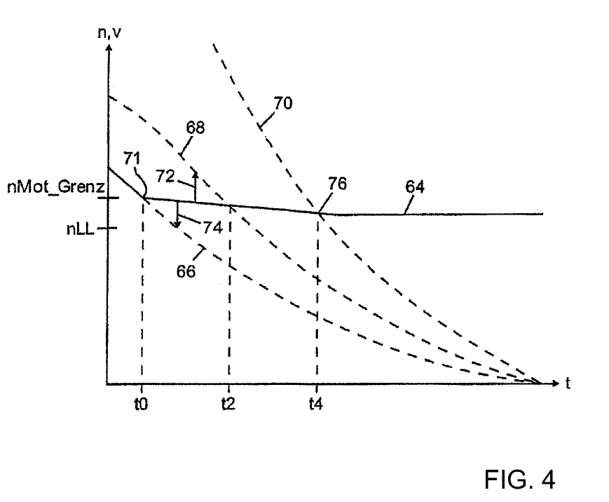

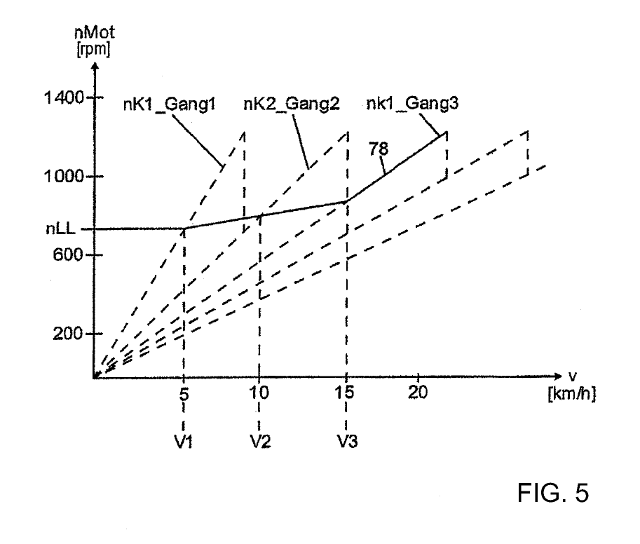

From the main program HP(B=0), a step 52 is repeatedly reached in which operating parameters BP of the drivetrain 10 are read in, which operating parameters BP are evaluated for an activation of the comfort-oriented control of the drivetrain proposed here. Details of the comfort-oriented control are explained in more detail further below with reference to FIGS. 4 and 5.

The evaluation is represented in FIG. 3 by a function f1(BP) which characterizes an entry into the comfort-oriented control and which is carried out in a step 54. Further below, a function f2 is similarly used, which characterizes an exit out of the comfort-oriented control, such that hysteresis between an entry into and an exit out of the comfort-oriented control is possible.

If the evaluation in step 54 yields that the comfort-oriented control should not be carried out, B is set to the value B=0. The response to the query in the subsequent step 56 is then negative, and the main program HP(B=0) in step 50 is then executed again. This means that the drivetrain 10 is controlled in the manner known from the prior art (FIG. 2).

In contrast, if the evaluation in step 54 yields that a comfort-oriented control of the clutches K1, K2 should take place, B is set to the value B=1. In one embodiment B is set to 1 if the vehicle is travelling with a low torque demand from the driver, that is to say with a small pedal angle Wped and a low speed in a low gear, for example in first or second gear. In one embodiment, it is for this purpose checked whether the throttle pedal angle Wped is smaller than a lower threshold value Wped_low and at the same time both the engine rotational speed nMot is lower than a threshold value nMot_Grenz and the driving speed v is also lower than a threshold value v_Grenz. In a further embodiment, the threshold value nMot_Grenz and/or the threshold value v_Grenz is dependent on a modulation factor MF which represents the roadway inclination and which is provided for example by an inclination sensor:

B=1 if:
a) Wped<Wped_Grenz and
b) Gear=gear 1 or gear 2, and
c) nMot<nMot_Grenz(MF) and v<v_Grenz(MF).

Typical values, to which the invention is not restricted, are:
Wped_Grenz<10% of the maximum pedal angle, 500 rpm<idle rotational speed<nMot_Grenz<(900 rpm on flat road, 1200 rpm on a hill).

If the conditions are met, the response to the query in the subsequent step 56 is positive and the program branches into the step 58 in which a modified main program HP(B=1) is executed to control the drivetrain 10 in a comfort-oriented manner.

From step 58, a step 60 is repeatedly reached in which operating parameters BP of the drivetrain 10 are read in, which operating parameters BP are evaluated for a deactivation of the comfort-oriented control of the drivetrain proposed here. The evaluation is represented in FIG. 3 by the function f2(BP) which characterizes an exit out of the comfort-oriented control. If the evaluation of the function f2(BP) in step 62 yields that the comfort-oriented control should not be carried out, B is again set to the value B=0 and the program branches back before the query step 56, which selects either a normal, non-comfort-oriented control by HP(B=0) in step 50 or comfort-oriented control HP(B=1) in step 58.

In one embodiment, B is set to 0 in step 62 if the clutch K1 in the first gear or the clutch K2 in the second gear is no longer slipping, that is to say if there is no longer a difference between the engine rotational speed nMot and the rotational speed of the input shaft of the associated partial transmission, and at the same time the vehicle speed v exceeds a threshold value v_Grenz or lies above the threshold value. The threshold value is preferably lower than 20 km/h and, in one embodiment, is dependent on the modulation factor MF in such a way that a higher limit value is generated when the vehicle is travelling on a hill than when the vehicle is travelling on a flat road.

Alternatively, B is set to 0 if the torque demand Wped from the driver exceeds a threshold value Wped_Grenz_Zug and the clutch which is to be closed is no longer slipping. Here, too, one embodiment provides that the threshold value Wped_Grenz_Zug is dependent on the driving speed v and the modulation factor in such a way that the threshold value Wped_Grenz_Zug likewise increases with increasing values of v and/or MF. Without restricting the generality of the invention, values for Wped_Grenz_Zug preferably lie between 50% and 70% of the maximum pedal angle.

A further embodiment provides that B is set to 0 if the driver manually downshifts from the second gear into the first gear. The first clutch K1 is then closed. If the clutch K1 is no longer slipping, and the engine rotational speed nMot exceeds a threshold value nMot_Grenz (v, MF) which is possibly further increased by a hysteresis offset, B is set back from B=1 to B=0. Without restricting the generality of the invention, the hysteresis offset is of the order of magnitude of 50 rpm.

FIG. 4 shows a smoothed profile 64 of the rotational speed nMot of the internal combustion engine 12, as is generated with the subject matter of the present invention during stopping of the vehicle under the condition B=1, that is to say with the comfort orientation of the drivetrain control activated. Before the time t0, the vehicle decelerates in the third gear. The clutch K1 is closed and the clutch K2 is open, wherein the second gear is already engaged in the second partial transmission TG2. Here, the rotational speed nMot is reduced proportionally to the reduction in the vehicle speed v until nMot reaches a threshold value nMot_Grenz at the time t0. It is true here, too, that the vehicle speed v is, with the associated clutch closed, proportional to the rotational speed nMot, with the proportionality factor being dependent on the transmission ratio and therefore on the engaged gear. Here, the dashed curves 66, 68 and 70 represent, in this sequence, the rotational speed nK1_Gang 3 of the input shaft 28 of the partial transmission TG1 in the third gear, the rotational speed nK2_Gang 2 of the input shaft 32 of the second partial transmission TG2 in the second gear, and the rotational speed nK1_Gang 1 of the input shaft 28 of the first partial transmission TG1 in the first gear. By means of corresponding scaling of rotational speed values and driving speed values on the ordinate, the time profile of the vehicle speed v has been placed in alignment with the profile of the rotational speed nMot in the third gear. The curve 66 therefore simultaneously represents rotational speed values and vehicle speed values. Similarly, the threshold value nMot_Grenz at the point 71 therefore simultaneously represents a rotational speed threshold value and a (lower) speed threshold value v_Grenz.

From the time t0, at which the threshold value nMot_Grenz is reached, the first clutch K1 is successively opened and the second clutch K2 is successively closed. In contrast to the prior art, the opening of the clutch K1 and the closing of the clutch K2 take place in a manner coordinated with one another, such that the engine rotational speed nMot, falling in a monotonous fashion, aligns with the idle rotational speed nLL of the internal combustion engine 12 as a target rotational speed. Here, the rotational speed nMot is set, alternatively or in addition to interventions into the control of the internal combustion engine 12, by coordinated control of the torque flows via the two clutches K1, K2. Up to the time t0, the clutch K2 was open and therefore transmitted no torque, while the clutch K1, as the vehicle decelerates in the overrun mode, transmits an overrun torque with which the internal combustion engine 12 is driven by the kinetic energy of the decelerating vehicle.

The gradual opening of the clutch K1 from the time t0 permits slip at the clutch K1. The gradual closure of the clutch K2 which takes place in parallel transfers the transmission of the overrun torque which is driving the internal combustion engine 12 to the clutch K2. As a result, after the time t0, the engine rotational speed nMot lies between values on the curve 68 of the second gear and the curve 66 of the third gear. The engine rotational speed nMot is too high for the third gear and too low for the second gear. Therefore the engine rotational speed nMot can be reduced by closing activation of the clutch K1 of the third gear and can be increased by closing activation of the clutch K2.

As a result of closing activation of in each case one of the two clutches K1, K2, the rotational speed nMot can thereby be increased or reduced. Here, in one embodiment, the activation preferably takes place in a regulated fashion. For this purpose, the actual value of the engine rotational speed nMot is compared with a nominal value, and from the regulating error, actuating variables S_K1 and S_K2 are formed, with which the torque transmission via the clutches K1 and K2 is individually controlled.

In FIG. 4, the increasing action of the closure of the clutch K2 is denoted by the arrow 72 and the reducing action of the closure of the clutch K1 is denoted by the arrow 74. In one preferred embodiment, the two clutches K1, K2 are controlled from the time t0 in such a way that the rotational speed nMot of the internal combustion engine 12 is aligned, in a monotonously falling fashion and therefore without the occurrence of local extrema, with the target rotational speed by suitable activation of the two clutches K1, K2.

At the time t2, the rotational speed nMot crosses the curve 68. At this time, the briefly-closed clutch K2 temporarily transmits all of the overrun torque, while the clutch K1 is temporarily fully opened. When the clutch K1 is open, the first gear is engaged. From now on, a closure of the clutch K1 has the effect of increasing nMot and holding the clutch K2 closed has the effect of reducing nMot. Similarly to the process between the times t0 and t2, the engine rotational speed nMot is subsequently aligned, in a monotonously falling fashion, with the target rotational speed by corresponding activation of the clutches K1, K2.

The target rotational speed in the form of the idle rotational speed nLL is reached at the time t4 by virtue of the curve 70 intersecting the value of the target rotational speed. To prevent the engine rotational speed nMot falling below the target rotational speed, not only the second clutch K2 but also the first clutch K1 is increasingly opened as the point of intersection 76 is approached.

FIG. 5 shows a transmission ratio map which illustrates linear dependencies of the engine rotational speed nMot on the driving speed v for the different gears of the dual-clutch transmission 14. The profile 78 represents the rotational speed nMot of the internal combustion engine 12, which initially corresponds to its idle rotational speed nLL. For comfort-oriented starting, at low speeds v<v1, both clutches K1, K2, which are open at v=0, are initially activated in a closing manner. Both clutches K1, K2 transmit traction torques of the internal combustion engine which set the vehicle in motion. In this phase, the engine rotational speed nMot is held at a nominal value, which in one embodiment corresponds to or is slightly higher than the idle rotational speed nLL, by interventions S_mot into the control of the internal combustion engine.

When the speed v1 is reached, the rotational speed nMot corresponds to the rotational speed nK1_Gang 1 of the input shaft 28 of the first partial transmission TG1. In the desired profile, which is dependent on the vehicle speed v, of the engine rotational speed nMot, the first clutch K1 can no longer transmit traction torques with the first gear engaged for speeds of v>v1. The first clutch K1 can instead only transmit overrun torques. The clutch K2, in contrast, initially continues to transmit a traction torque. Similarly to stopping, the two clutches K1, K2 are initially operated with continued slip with increasing speed v, and at speeds of v>v1, the rotational speed nMot of the internal combustion engine 12 is set to a nominal value by suitable activation of the clutches K1, K2 with gears simultaneously engaged in both partial transmissions TG1, TG2. The setting preferably takes place by regulation.

In the speed range v1<v<v2, in the illustrated profile of nMot, the clutch K1 transmits an overrun torque while the clutch K2 transmits a traction torque. In the speed range v2<v<v3, in the illustrated profile of nMot, the clutch K1 transmits a traction torque while the clutch K2 transmits an overrun torque. If the traction torque prevails, the rotational speed nMot decreases. If the overrun torque prevails, the rotational speed nMot increases. When the speed v3 is reached, the engine rotational speed nMot corresponds to the rotational speed nK1_Gang3 of the input shaft 28 of the first partial transmission TG1, such that there is no rotational speed difference at the clutch K1. In the illustrated embodiment, at this time, the clutch K1 is activated in such a way that it is fully opened. Here, the complete opening of one clutch need not coincide precisely with the complete closure of the other clutch. It is essential merely that, when gears are simultaneously engaged in both partial transmissions TG1, TG2, at least one of the two clutches K1, K2 is operated with slip in order that the dual-clutch transmission 14 does not lock.

From the speed v3, which in the illustration of FIG. 5 is approximately 15 km/h, the comfort starting function is deactivated and the engine speed rises linearly, and with a gradient which is determined in the dual-clutch transmission 14 by the transmission ratio of the third gear, until a further shift process takes place.

The smooth nMot profiles 64 in FIG. 4 (stopping) and 78 in FIG. 5 (starting) no longer have pronounced local maxima or minima, in contrast to the nMot profile 48 in FIG. 2, that is to say according to the prior art. As a result of the elimination of the extrema, the associated jolts and incitement of oscillation are also eliminated. This results in significantly improved driving comfort.

FIG. 5 has been explained with regard to a starting situation. The relationships explained by FIG. 5 however also apply to driving situations at constant speeds and to stopping the vehicle under the assumption of an activated comfort function (B=1).

1. A method for controlling a drivetrain of a motor vehicle having a dual-clutch transmission with a first partial transmission and a first clutch and with a second partial transmission and a second clutch, which comprises the steps of:
operating the drivetrain with a gear engaged in the first partial transmission and a further gear engaged in the second partial transmission at a same time; and
operating the first clutch and the second clutch with slip at a same time, the first clutch and the second clutch being activated in a manner coordinated with one another such that a rotational speed of an internal combustion engine one of assumes a predetermined value and maintains the predetermined value.

2. The method according to claim 1, which further comprises predetermining the predetermined value of the rotational speed of the internal combustion engine in dependence on a speed of the motor vehicle.

3. The method according to claim 2, which further comprises carrying out the method during deceleration of the motor vehicle.

4. The method according to claim 1, which further comprises carrying out the method during at least one of a starting of the motor vehicle and an acceleration of the motor vehicle from speeds which lie below a predetermined first speed threshold value.

5. The method according to claim 1, which further comprises carrying out the method if a throttle pedal angle is smaller than a lower threshold value and the rotational speed is at a same time lower than a threshold value.

6. The method according to claim 5, which further comprises forming the threshold value to be dependent on a driving speed.

7. The method according to claim 1, which further comprises carrying out the method until the first clutch in the first gear or the second clutch in the second gear no longer slips, and at a same time a vehicle speed exceeds a threshold value or lies above the threshold value.

8. The method according to claim 1, which further comprises carrying out the method until a throttle pedal angle exceeds a threshold value and a clutch which is to be closed is no longer slipping, or until a driver manually downshifts from the second gear into the first gear, the clutch is no longer slipping, and the rotational speed exceeds a threshold value.

9. A control unit for controlling a drivetrain of a motor vehicle having a dual-clutch transmission with a first partial transmission and a first clutch and with a second partial transmission and a second clutch, the drivetrain being operated with a gear being engaged in the first partial transmission and a further gear being engaged in the second partial transmission at a same time and with the first clutch and the second clutch being operated with slip at a same time, the control unit comprising:
a controller programmed to activate the first clutch and the second clutch in a manner coordinated with one another such that a rotational speed of an internal combustion engine one of assumes predetermined value and maintains the predetermined value.

10. The control unit according to claim 9, wherein said controller is programmed to predetermine the predetermined value of the rotational speed of the internal combustion engine in dependence on a speed of the motor vehicle.

11. The control unit according to claim 9, wherein said controller is programmed to carrying out the method step of claim 3.

12. The control unit according to claim 9, wherein said controller is programmed to carrying out the method step of claim 4.

13. The control unit according to claim 9, wherein said controller is programmed carrying out the method step of claim 5.

14. The control unit according to claim 9, wherein said controller is programmed carrying out the method step of claim 6.

15. The control unit according to claim 9, wherein said controller is programmed carrying out the method step of claim 7.

16. The control unit according to claim 9, wherein said controller is programmed carrying out the method step of claim 8.
